(19) United States
(12) Patent Application Publication
(10) Pub. No.: US 2008/0272600 A1
(43) Pub. Date: Nov. 6, 2008

(54) LEVER OPERATED PIVOTING FLOAT WITH GENERATOR

(76) Inventor: Chris Olson, Houston, TX (US)

Correspondence Address: LAW OFFICE OF DAVID MCEWING, P.O. BOX 231324, HOUSTON, TX, 77023, US

(21) Appl. No.: 12/117,432

(22) Filed: May 8, 2008

Related U.S. Application Data
(63) Continuation-in-part of application No. 11/799,930, filed on May 2, 2007.
(60) Provisional application No. 60/994,213, filed on Sep. 18, 2007.
(60) Provisional application No. 61/123,484, filed on Apr. 9, 2008.
(60) Provisional application No. 61/072,678, filed on Apr. 2, 2008.
(60) Provisional application No. 61/003,247, filed on Nov. 15, 2007.
(60) Provisional application No. 61/003,242, filed on Nov. 15, 2007.

(51) Int. Cl. F03B 13/12

(52) U.S. Cl. 290/53; 60/497

(57) ABSTRACT

The disclosure teaches improvements of the lever operated pivoting float with generator. The improved parts include an improvement in the torsion spring system, more streamlined floatation, counter weighted and ballast balanced, buoyant lever arm and a shock absorbing lever arm. The device can also be use up side down. The disclosure also teaches a floating electric power generator including a buoyant float component, a lever arm pivoting on a shaft of the float and attached to a submerged structure, and an electrical generator that includes a shaft that turns in response to the pivoting of the lever arm. Also disclosed is a floating electric power generator including a float in a “U” or horseshoe shape with an opening for mounting the pivoting lever arm on a shaft, a generator contained within one arm of the float, a combination spring and shaft component wherein the springs are compressed by pulling down of the pivoting lever arm, and energy from the compression or relaxation of the power is communicated to the generator shaft to power the generator. The disclosure teaches a floating electric power generator comprising: a float in a “U” or horseshoe shape with an opening for mounting a pod shaped pivoting lever arm on a shaft, a generator contained within the lever arm pod, a chain, coil spring and end cap configuration in communication with a shaft within the lever arm wherein the chain is wrapped about the shaft when the lever arm is pulled down and thereby compressing the spring, a gear component on the shaft in communication with at least one other gear fixed to the generator rotating shaft so that as the lever arm rotates about the shaft, the generator rotating shaft is turned. The pod holds the weight of the generator and the generator acts as a counter weight and ballast to force the back end of the float under as it is lifted out of the water. The pivoting floatation device has large ends and thinner mid sections so that the float will enter the water smoothly.

### RELATED APPLICATIONS

This application claims the benefit of and priority to provisional application No. 60/994,213 entitled “Float Device for Lever Operated Pivoting Float with Generator” filed Sep. 18, 2007 and which is incorporated by reference herein. This application also claims the benefit of and priority to provisional application No. 61/123,484, entitled “Improved Torsion Spring System for Lever Operated Pivoting Float with Generator” filed Apr. 9, 2008, and which is incorporated by reference herein. This application also claims the benefit of and priority to provisional application No. 61/072,678 entitled “Improved Torsion Spring System for Lever Operated Pivoting Float with Generator” filed Apr. 2, 2008, and which is incorporated by reference herein. The application also claims the benefit of and priority to provisional application No. 61/003,247 entitled “Lever Arm and Generator Housing” filed Nov. 15, 2007, and No. 61/003,242 entitled “Energy Steady Release Device”, filed Nov. 15, 2007.

This application incorporates by reference herein provisional application 60/880,321 filed Jan. 12, 2007 and entitled “Lever Operated Pivoting Float with Generator”, provisional application 60/904,749 entitled “Lever Operated Pivoting Float with Generator” filed Mar. 2, 2007 and non-provisional application Ser. No. 11/799,930 filed May 2, 2007 and entitled “Lever Operated Pivoting Float with Generator”.

This application is a CONTINUATION IN PART of application Ser. No. 11/799,930 filed May 2, 2007 and entitled “Lever Operated Pivoting Float with Generator” and which is incorporated by reference herein.

### 1. FIELD OF USE

Generation of electricity from ocean, bay or lake wave action.

### 2. RELATED TECHNOLOGY

Numerous patents have been issued utilizing the movement of floats in the water to generate power. However these devices have not been successful or utilized.

### SUMMARY OF DISCLOSURE

The disclosure is a patentable improvement to the lever operated pivoting float with generator. The improved parts include an improvement in the torsion spring system, i.e., a system of coil springs used for torsion in float and lever. The improvements also pertain to more streamlined floatation allowing the float to more efficiently pivot in the water, a counter weighted and ballast balanced and buoyant lever arm, shock absorbing device in two piece extendable lever arm component, a generator that turns in one direction with the lever capable of going in two directions. The device can also be used up side down suspended to a structure above the water such as a pier or boat. The disclosure teaches a method for the operation of the pivoting lever arm in conjunction with a spring device that returns the arm to its original position after passage of a wave. In one embodiment, the method also includes placement of the electrical power generator at one end of the pivoting arm that acts as a counter balance and ballast. In another embodiment, the generator and spring mechanism are contained within the float mechanism.

The disclosure also teaches a spring configuration adapted for use with the lever arm and with the generator. The disclosure also teaches a shaped floatation device that includes the ability to become smoothly submerged (wholly or partially) in response to a large wave swell or tidal action.

### SUMMARY DESCRIPTION OF DRAWINGS

The accompanying drawings, which are incorporated in and constitute a part of the specification, illustrate embodiments of the invention. These drawings, together with the general description of the invention given above and the detailed description of the embodiments given below, serve to explain the principles of the invention.

FIG. 1 is a top view of the lever operated pivoting “U” shaped float with generator and torsion spring system.

FIG. 2 is a side view of the shaft, coil spring and connecting chain or belt. The coil spring acts as a torsion spring for the shaft.

FIGS. 3 and 4 show the coil spring and shaft in different positions, i.e., compressed and uncompressed. FIG. 3 shows the lever arm rotating and exerting force on the coil spring. FIG. 4 shows the lever arm and coil spring in a more relaxed position exerting less force to the coil spring and the chain partially unwound from the shaft.

FIG. 5 is a view of the “U” shaped lever operating pivoting float with the pivoting lever attached to a line and anchor.

FIG. 6 illustrates three coil springs used with a belt or chain mechanism in relation to a shaft.

FIG. 7 illustrates a pod shaped lever arm wherein the generator is contained in the enlarged pod end and the opposite end of the lever arm is attached to a submerged anchor or similar structure. The pod contains three springs, a generator, gears and a fixed shaft around which the arm pivots.

FIG. 8 shows the float and lever dissembled giving an indication of where the coil spring is located in the front of the lever arm.

FIG. 9 illustrates the action of an ocean swell on the arched pivoting flotation device. “A” illustrates the floatation device in a wave trough. Note the position of the float and the lever arm. “B” illustrates the start of the submersion process. The lever arm has now pivoted straight down in line with the rod and line. “C” illustrates the complete submersion of the pivoting float. Note the float has pivoted into line with the lever arm, rod and line. The illustration shows how the arched shape of the pivoting float smoothly enters the water without the bottom of the float front being lifted out of the water.

FIG. 10 illustrates a flexible cushioning device component placed at the end of the lever arm and used to cushion the pulling action of the line attached to the anchor and the flotation device. Also at the end of the lever, there is a moveable component.

FIGS. 11A and 11B illustrate the lever operated pivoting flotation device with the pivoting lever arm secured to an upper fixed object and used to generate electricity in the up side down position, i.e., the top of the float is submerged.

FIG. 12 illustrates an isometric view of the pivoting lever arm with the pod shaped back end holding the generator and related components. The pod shape also adds buoyancy to the lever arm. The generator inside the pod provides counterweight and ballast to the device.

FIG. 13 is a perspective view of the modified pivoting float and lever design. Also illustrated is the spring loaded lever arm at the back portion of the float and connected to a rod extending into the water.

FIGS. 14A, 14B and 14C illustrate one embodiment of the mechanisms powering the generator of the device.

### DETAILED DESCRIPTION OF DISCLOSURE

While this invention is susceptible of embodiments in many different forms, there is shown in the drawings and will herein be described in detail embodiments of the invention with the understanding that the present disclosure is to be considered as an exemplification of the principles of the invention and these examples are not intended to limit the broad aspect of the invention. The above general description and the following detailed description are merely illustrative of the subject invention and additional modes, advantages and particulars of this invention will be readily suggested to those skilled in the art without departing from the spirit and scope of the invention.

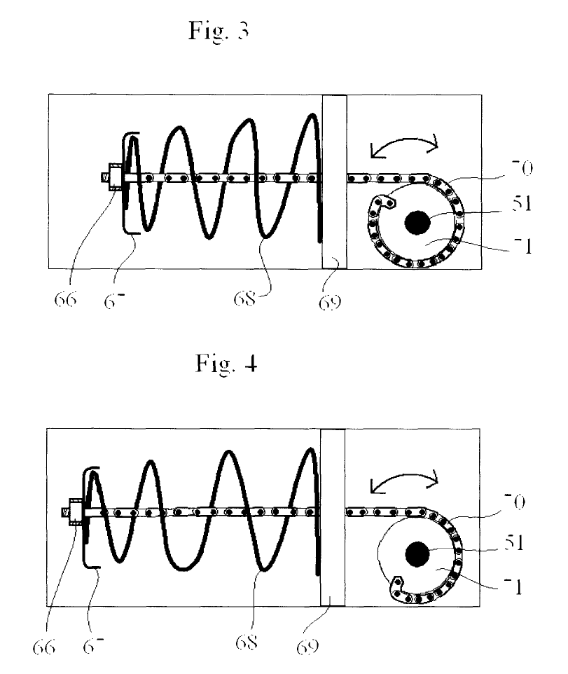

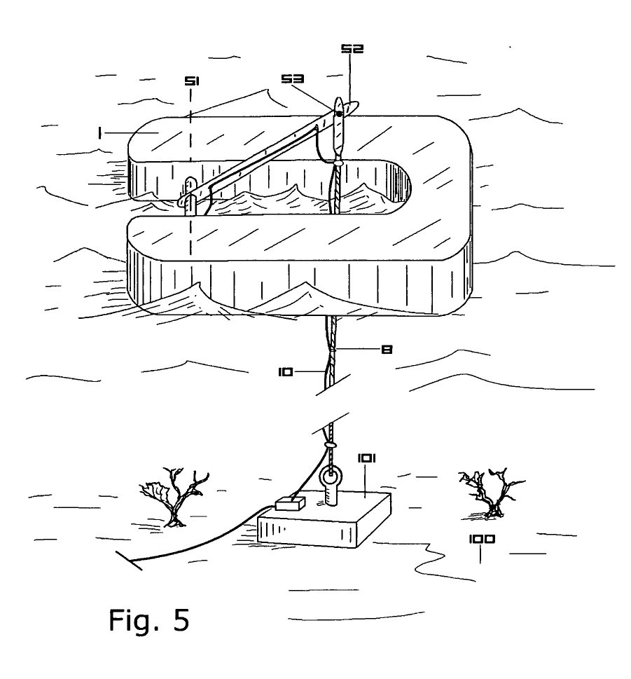

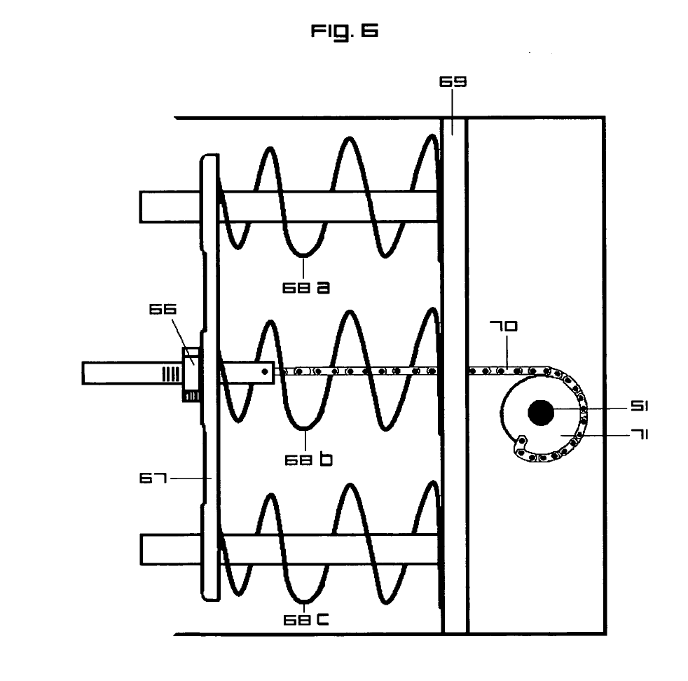

The disclosure pertains to improvement in the return spring used in the lever operated pivoting float with generator. For example, see FIG. 2. As part of the operational cycle, the lever arm is pulled down as a result of ocean waves lifting the float and a torsion spring returns the lever to the upright position. The lever arm is fixed to an anchor or other submerged structure. See FIG. 5 for example. One change in the relationship between the arm and the anchor is the pivoting action of the lever arm.

To provide more torsion to the generator drive shaft, a coil spring or multiple coil springs are held in place perpendicular to a shaft within the float or lever and a chain is used to compress the coil spring as a result of either rotating the shaft or the chain winding around the immobile shaft as the lever arm is pulled down (and the lever arm pivots on the shaft). The chain is securely fastened to the drive shaft and partially encircles the shaft so when the chain is rotated about the shaft caused by movement of the lever arm, the chain wraps about the shaft and the chain is shortened. Shortening the chain compresses the coil spring to which the chain is fastened. See FIGS. 3 and 4.

In one embodiment, the improved design uses multiple coil springs sandwiched between a fixed metal plate and a movable metal plate. See FIGS. 3 and 4. A chain is used to compress the plates and therefore the springs as a result of rotating the chain about the shaft. This in effect is mechanically using a coil spring to do the job of the torsion spring. For this application, there is a great need for excessive torsion applied to a shaft that rotates less than 360 degrees. This can be achieved by using a large coil spring or multiple coil springs in series.

The improved design will allow for greater torsion forces than could be achieved by using a torsion spring. Using multiple coil springs positioned inside of the lever operated pivoting float as return springs for the lever arm will increase the electrical output and save space.

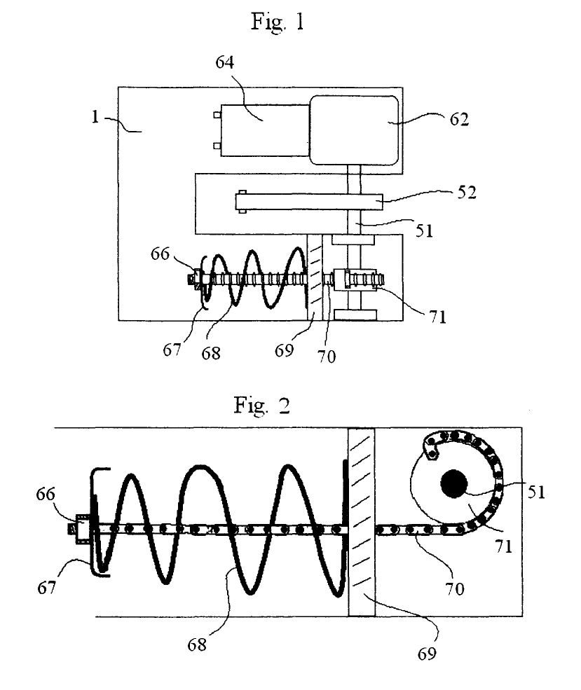

FIG. 1 is a top view of the lever operated pivoting float with generator and represents one embodiment of the device subject of the disclosure. The float 1 portion is “U” shaped or horse shoe shaped with at least one gear in the housing 62 and generator 64 on one side and a coil spring 68 on the other. In this embodiment, downward or upward movement of the lever arm 52 activates the shaft 51. The rotation of the shaft activates the generator on one end and compresses a spring 68 on the other. The rotating shaft external to the float may be protected by a twisting bellow (not shown). The wall of the bellow is molded or otherwise formed to accommodate repeated twisting motion of the generator powering shaft resulting from the limited up and down motion of the pivoting lever arm and intended to seal water out.

There is a chain or belt 70 (hereinafter “chain”) fastened to the shaft of the pivoting lever arm and partially encircles that shaft. The opposing end of the chain is threaded through the coil spring and is fastened to a cap 67 on top of the coil spring with a nut 66. The coil spring is fastened to a fixed section 69 of the float and is compressed as the cap 67 is forced down on the spring by rotating the chain 70 about the shaft 51. When the spring relaxes, the rotating shaft reveres direction and the lever arm returns to its original position.

FIG. 2 is a side view of a portion of the embodiment of FIG. 1 and shows the shaft 51 and coil spring 68. The coil spring is forced against the solid section 69 of the float to compress and expand as the shaft is turned back and forth. The chain extends from shaft 51 to the spring cap 67. The shaft may have a sprocket 71 or pulley to which the chain is fixed.

In other embodiments, the shaft can be in a fixed position (non-rotating). The coil spring assembly attached inside the lever arm or generator housing can rotate about the fixed shaft causing the chain to be wrapped around the shaft, thereby compressing the spring. When the spring relaxes, the generator and lever arm also rotate. The shaft may contain a sprocket or pulley that engages the shaft connected to the generator. FIGS. 3 and 4 show the coil spring and shaft in different positions. FIG. 3 shows the chain 70 wrapped about the shaft 51 and exerting force on the shaft 51 that is connected to the lever arm and generator. FIG. 4 shows the shaft and coil spring in a more relaxed position exerting less force on the lever arm. The relaxation of the spring causes the lever arm (not shown) to move to its original position. This movement causes the gears and generator drive shaft within the lever arm to move.

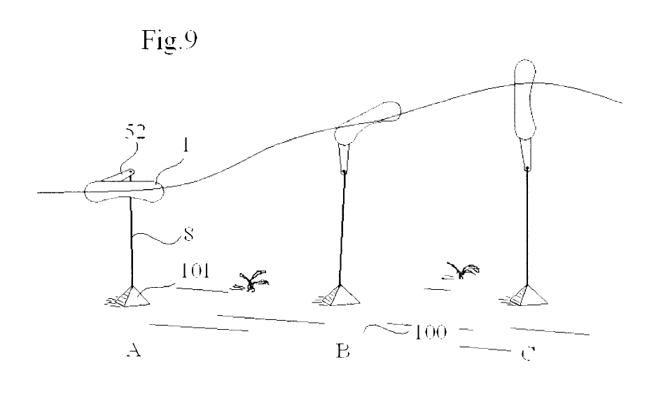

FIG. 5 is a view of the lever operated pivoting “U” shaped flotation device with generator in the ocean. Included in the Figure is a pivoting drive shaft 51. The lever arm 52 is in the upright position and is connected to the ocean floor 100 with a cable 8 and anchor 101. Also shown is the rod 54, and the connection 53 on the pivot arm. As waves lift the float, the lever arm is pulled down rotating the generator and exerting force on the coil spring. (See FIG. 9) The coil spring exerts that energy by returning the lever arm to the upright position as the wave subsides. (See FIGS. 3 and 4.)

FIG. 6 shows three coil springs 68A, 68B, and 68C in series that are compressed by the chain 70, sprocket 71 and pivoting drive shaft 51. The chain may be a flat chain that encircles a large diameter shaft.

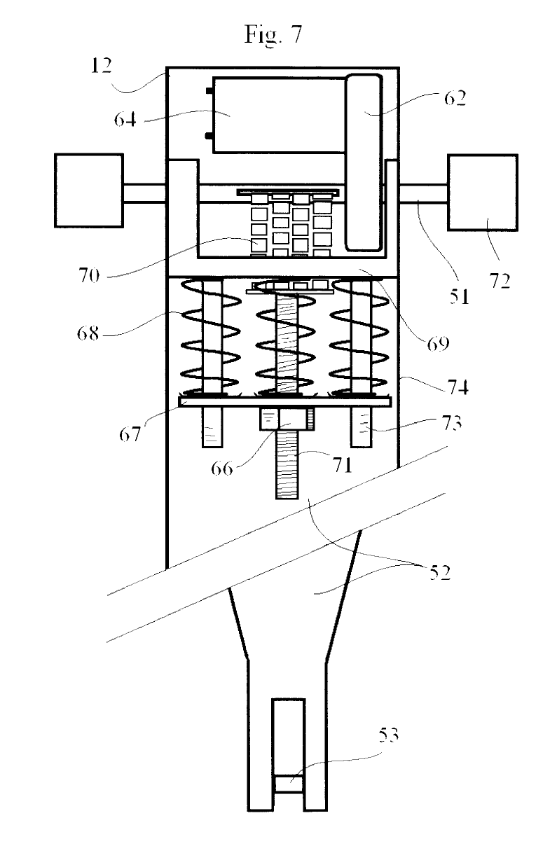

In one embodiment (FIG. 7) of the invention, the generator may be located in a pod like structure at one end of the pivoting lever arm. The generator and related components may act as a counter weight to the extended lever arm. It will be appreciated that the lever arm, attached to a submerged anchor or similar structure, is periodically pulled beneath the ocean surface by the ocean swells and tides and should return to its normal position.

The pod section of the backend of the pivoting lever arm can be buoyant so as to help keep the device floating at the ocean surface and to help return the front end of the arm to the upright position. The weight of the generator will help submerge the device when it is elevated out of the water. The complete device is to be used to generate electricity from the interaction of the lever arm with ocean waves.

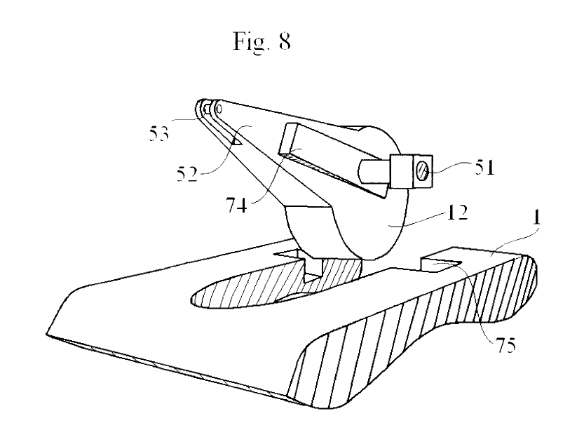

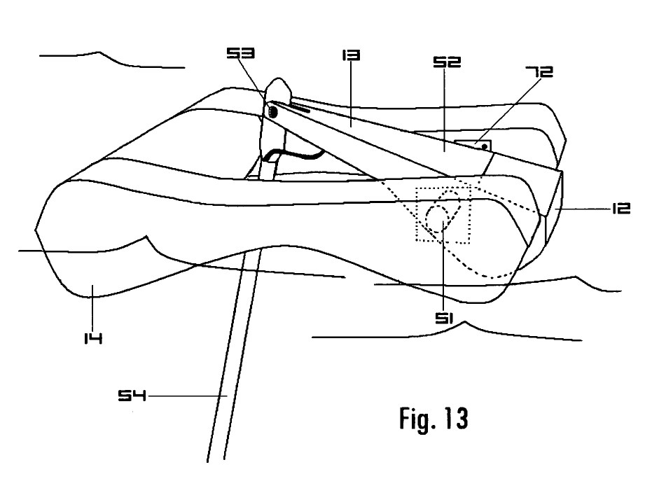

FIG. 7 illustrates a lever arm 52 that has a shaft 51 protruding from each side with a mounting plate 72 on the end of the shaft and a compartment or pod 12 to house the generator and gears. FIG. 7 illustrates lever arm 52 that is mounted to a connecting device or rod 54 (see FIG. 13) that is connected to the ocean floor or a relatively stable object to pull against (not shown). The lever arm 52 is connected to the floatation device (not shown) by a shaft 51 with a fixtures 72 on the end of the pivoting drive shaft 51 and that fits into slots in the float (see FIG. 8). Other attachment mechanisms may be used. The lever arm has a compartment or pod 12 to house the generator and acts as additional floatation to help keep the generator and floatation buoyant. The shaft passes through the gear housing 62. The shaft may include a sprocket engaged with at least one gear in the housing. As the lever arm rotates about the shaft in conjunction the chain 70, springs 68, end cap 67 attached to a threaded rod 71 and nut 66 and immovable housing fixture 69, the gear turns, which causes the generator 64 shaft to turn.

FIG. 7 shows the inside of the lever arm 52 with the shaft 51 that does not rotate but is fixed so that the lever rotates around the shaft. The generator 64 is fixed to the rotating housing in the lower back portion of the lever housing 52 so that it can also act as a counter weight and a ballast weight. The ballast weight helps push the rear of the float under the water surface as it is lifted above the flotation device. The gear box 62 is attached to the generator 64 and the main shaft 51. As the lever rotates around the shaft, it activates the generator because the generator and gearbox are also rotating around the shaft. The coil spring 68 is held in place perpendicular to the drive shaft and a chain 70 is used to compress the coil spring as a result of rotating the lever arm. The chain is securely fastened to the drive shaft and partially encircles the shaft so when the lever arm is turned the chained is pulled. Turning the lever arm shortens the chain that compress the coil spring that the chain is fasten to.

FIG. 8 shows the float 1 and lever 52 in a disassembled state. The lever shaft 51 will sit in the slots 75 in the float and the shaft will not rotate. The lever will rotate around the shaft. The generator and gears are located in the back of the lever arm 12. The raised section 74 on the side of the lever indicates where the spring may be housed. See FIG. 7 for example.

The improvement of the invention allows the flotation device to easily and smoothly be submerged in the ocean without lifting the front of the float as the back is pulled under as a result of the ocean wave action. The front and back of the float are thicker and more buoyant than the thinner middle section that is slightly elevated out of the water.

The disclosure also pertains to improvements in the design of the float used in the lever operated pivoting float with the generator. As part of the operational cycle, the float is periodically pivotally pulled beneath the ocean surface by ocean swells and tides. The pulling action is from the lever arm pivoting downward and that is secured to a fixed length line attached to a non buoyant structure beneath the surface. The pulling action next submerges the back end of the float. The pulling action upon a large buoyant middle section has caused the front end of the float to become elevated out of the water. This may be undesirable. The improved float design eliminates this action.

FIG. 9 illustrates an improved embodiment of the pivoting float design being a “U” shape or resembling the shape of a horse shoe. The improved pivoting float design discussed below makes the front portion 34 of the floatation device thicker in a cam shape and the back 32 of the floatation (secured to the subsurface structure with a lever arm) is also thicker in a cam shape. A cross sectional view of the back and front section would show an elliptical or oval shape. The middle or side portion 31 of the float are thinner and curved upward. The curvature may cause the sides to be elevated out of the water. See also FIG. 13.

FIG. 9 illustrates the process wherein the back portion of the improved pivoting float 1 is pulled beneath the surface. Note the change in position of the lever arm 52. The rod and line 3 is taut and fixed to the anchor 101. Note also that the front 34 portion of the float is not elevated above the surface.

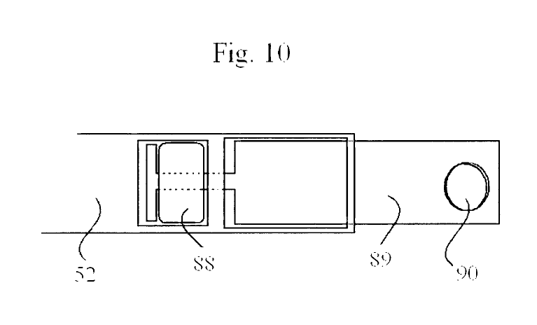

FIG. 10 illustrates a flexible cushioning device 88 that serves as a cushion to the lever arm 52 from loads from the rod or line attached to the end of the lever arm 90 to an anchor or other submersible device. It will be appreciated that this is the front end of the lever arm and opposite the end that may contain the generator. The end of the lever arm has two pieces one sliding inside the other 92 using the device to cushion extreme forces.

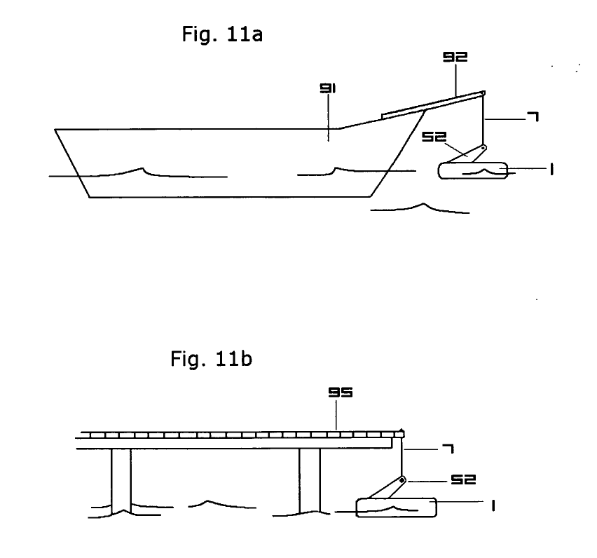

FIGS. 11A and 11B illustrate the float 1 operated by the line from the lever arm 52 suspended from an object above the ocean surface such as a boat 91 or pier 95. It will be appreciated that the float is upside down in this configuration. The device subject of the disclosure also works when upside down and floating in the water. The line from the lever arm can be tied to boat 91 or pier 95 or other object of significant mass greater than the device of the disclosure. FIGS. 11A and 11B illustrate the device with the line 7 taut and the lever arm 52 in an upward position. It will be appreciated that this is the same as the flotation device 1 in the normal right side up position floating on an ocean swell. In the instant case the flotation device may be in a wave trough relative to the boat or pier. The change in height or elevation of the boat deck to the water surface causes movement in the lever arm which powers the generator. It will be appreciated that in a relaxed state, the lever arm will be beneath the water surface.

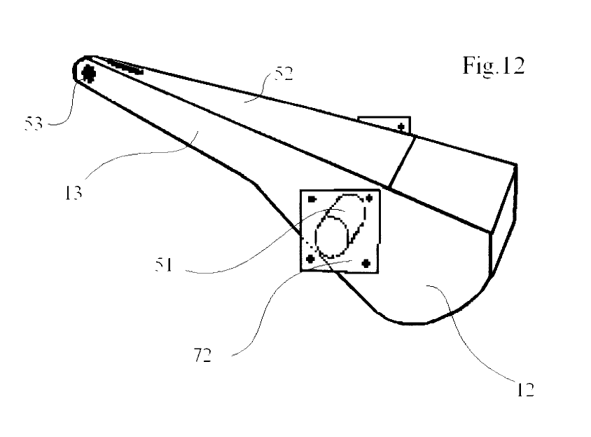

FIG. 12 illustrates the components of one embodiment of the disclosure wherein the generator 62 is located within one end of the pivoting float 1. The pod shaped end 12 of the pivoting arm is located between the two arms of the float and is attached to an immobile shaft 51. The shaft may contain a fixed gear. As the pivoting lever arm moves in response to ocean waves, the fixed gear turns one or more gears that are in communication with the generator shaft, hence powering the generator 64. The rotating gears within the housing 62 can be installed in alternate configurations so that the rotation of the generator shaft is the same regardless whether the arm is pivoting up or down.

In the embodiment shown, the pivoting arm is also controlled by the spring configuration comprising one or more coil springs 68 wherein the base of the spring is resting on an immovable structure 69. The second end of the coil spring is clamped to a chain like device 70 fixed to the immobile shaft 51 around which the lever arm pivots. As the lever arm pivots downward in response to an ocean wave, the chain winds about the shaft, thereby shortening length of chain controlling the spring. The spring is thereby compressed by movement of the moveable cap or plate. When the wave passes, the energy stored within the compressed spring is released to reposition the lever arm to the upright position as shown, for example, in FIG. 8.

FIG. 12 illustrates a pivoting lever rod configured to hold a generator, gears, and springs. This equipment is located in the back section of the lever arm housing 12. Also illustrated is the narrowing of the housing 13 at the attachment point 53 for a line or rod (not shown) that will be attached to an anchor or other submerged device. Also illustrated are the shafts 51 upon which the lever arm pivots.

The back end 12 houses the heavy generator. The portion of the arm containing the generator can be buoyant so as to help keep the device floating at the ocean surface and to help return the arm to the upright position. The weight of the generator will help submerge the device when it is elevated out of the water by the pulling of the lever arm down.

FIG. 13 illustrates the combined improved float and the pod pivoting lever. The equipment containing end of the pivoting lever is at the back 12. The pivoting arm narrows 13 to the attachment component 53. A rod 54 may be attached to the end of the pivoting lever arm. Also illustrated is the shaft 51 on which the lever arm pivots.

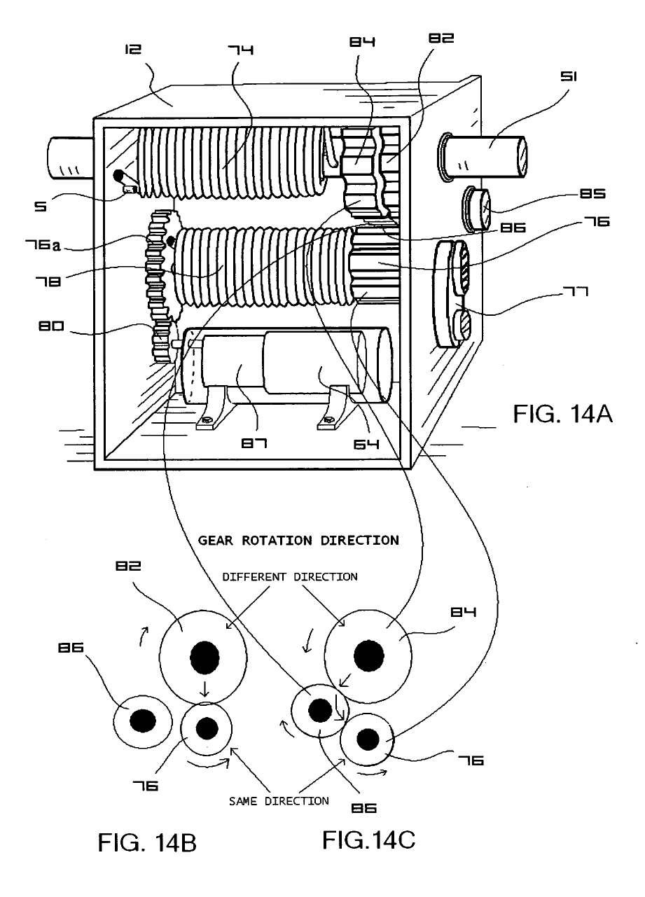

FIGS. 14A, 14B and 14C illustrates one embodiment for conversion of the rotational motion of the generator on the rotating or pivoting shaft 51 to energy driving the generator shaft. FIG. 14A illustrates the device with two gears 84, 82 mounted on one way clutch bearings that are on the first shaft 51 that engage in opposite directions. The first gear 82 communicates directly with the gear on the second shaft 76 and the second gear 84 communicates with a gear 86 mounted on a free spinning bearing mounted on a stub shaft 85 mounted to the device housing 12 that communicates with the gear on the second shaft 76. This causes the second shaft to rotate in one direction being driven by the first shaft spinning in clockwise and counter clockwise directions. Said another way, the first shaft rotates in both a clockwise and counter clockwise direction and communicates that rotational energy in to the second shaft in only one direction. The second shaft may be connected to the generator 64 drive shaft by gear 80 in communication with rotating gear 76A at the end of the second shaft. FIG. 14A also illustrates torsions springs 74 and 78.

FIGS. 14B and 14C illustrate the turning of the second shaft 76 is a single direction from the alternately clockwise and counter clockwise direction of the first shaft through gears 82 and gears 84 and 86 in combination.

In the embodiment illustrated by FIG. 14A, the pivoting shaft or housing rotating on the fixed shaft is estimated at 2 rpm. The second shaft is estimated to rotate at 8 rpm and the gear 80 turning the generator 64 is estimated at 32 rpm corresponding to a generator speed of 1,920 rpm.

While specific embodiments have been illustrated and described, numerous modifications are possible without departing from the spirit of the invention, and the scope of protection is only limited by the scope of the accompanying claims. This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

What I claim is:

1. A floating electric power generator comprising
a) a buoyant pivoting float;
b) a lever arm pivoting on a shaft of the float;
c) one end of the lever arm attached to a submerged structure; and
d) an electrical generator further comprising a shaft in communication with and that turns in response to the pivoting of the lever arm.

2. The floating electric power generator further comprising a float comprising large ends and raised sides.

3. The floating electric power generator of claim 1 further comprising a cushioning device at the end of the extendible lever arm.

4. The floating electric power generator of claim 1 further comprising:
a) a pivoting float in a “U” or horseshoe shape with an opening for mounting the pivoting lever arm on a shaft;
b) a generator contained within a first arm of the pivoting float;
c) a combination spring and shaft component within a second arm of the pivoting float wherein the springs are compressed by pulling down of the pivoting lever arm; and
d) energy from the compression or relaxation of the springs is communicated to the generator shaft to power the generator.

5. The floating electric power generator of claim 1 further comprising:
a) a pivoting float in a “U” or horseshoe shape on which a pivoting lever arm on a shaft;
b) a generator contained within the lever arm;
c) a chain, coil spring and end cap configuration in communication with a first shaft within the lever arm wherein the chain is wrapped about the first shaft when the lever arm is pulled down and thereby compressing the spring; and
d) a gear component on the first shaft in communication with at least one other gear fixed to the second generator rotating shaft so that as the lever arm rotates about the first shaft, the second generator rotating shaft is turned.

6. The floating electric power generator of claim 5 further comprising stepped up gears in conjunction with the fixed gear of the shaft and the rotating generator shaft.

7. The pivoting lever arm of claim 5 further comprising buoyant material in the pod portion of the lever arm.

8. The pivoting lever arm of claim 5 wherein the generator is located in a back portion of the lever arm and acts as a ballast weight to the front portion of the lever arm.

9. The pivoting lever arm of claim 8 wherein the generator contributes weight to the back end of the pivoting flotation device.

10. The pivoting lever arm of claim 5 wherein the generator is located in a back portion of the lever arm and acts as a counter weight assisting the lever arm in returning to the upright position.

11. The pivoting lever arm of claim 5 wherein the coil spring, cap and chain accelerate the return of the lever arm to its original position.

12. The floating electric power generator of claim 5 further comprising the chain being wrapped around the stationary first shaft as the lever arm is pulled down.

13. A pivoting submersible “U” shaped or horseshoe shaped floatation device wherein:
a) the front end and the back end of the device further comprising lever arm pivot structure is thicker than the sides of the flotation device;
b) the sides of the flotation device are curved upward.

14. The pivoting floatation device of claim 13 wherein the bottom of the pivoting flotation device front end is not elevated above the water surface as the back end is pulled beneath the surface by action of the lever arm pivot structure secured to an anchor or other submerged structure.

15. A floating electric power generator comprising:
a) a submersible pivoting flotation device;
b) a lever arm that pivots on a stationary first shaft of the pivoting flotation device and is attached to an anchor;
c) a sprocket attached to the first shaft; and
d) at least one rotating gear engaged with the sprocket and a rotating generator shaft wherein the generator is contained in the lever arm.

16. The floating electric power generator of claim 15 further comprising a second gear engaged with the sprocket and in communication with a third gear communicating with the rotating generator shaft so that the generator turns in one direction regardless of direction of the pivoting lever arm.

17. A method of generating electricity comprising:
a) placing a pivoting lever arm on a submersible flotation device;
b) placing the pivoting flotation device on the ocean surface;
c) attaching a line from the front end of the lever arm to a submerged object;
d) allowing the lever arm to pivot up and down in response to ocean waves; and
e) utilizing the motion of the lever arm to rotate a generator shaft to create electricity.

18. The method of claim 17 further comprising:
a) utilizing the motion of the lever arm to compress at least one spring;
b) releasing of the compressed spring moves the lever arm to an original position;
c) moving the lever arm causes a first gear engaged with a sprocket on a first shaft of the pivoting flotation device to turn; and
d) turning of the first gear turns at least one second gear that turns a rotational shaft of a generator.

19. A floating electric power generator comprising
a) a buoyant pivoting float component;
b) a lever arm pivoting on a shaft of the float;
c) one end of the lever arm attached to an object above the water surface;
d) an electrical generator further comprising a shaft in communication with and that turns in response to the pivoting of the lever arm.

20. A floating electric power generator of claim 19 further comprising a lever arm that pivots on a shaft in the pivoting floatation component, that the end of the pivoting arm attached to the pivoting floating component is beneath the ocean surface when in a relaxed position.

21. The method of claim 17 further comprising a configuration of gears at the end of the first rotating shaft wherein a first gear is in communication with a third gear that in the communication with a second shaft and a second gear is in direct communication with the second shaft.

22. The method of claim 21 further comprising the second shaft rotating the generator.
